(19) United States
(12) Patent Application Publication
(10) Pub. No.: US 2025/0233492 A1
(43) Pub. Date: Jul. 17, 2025

(54) ELECTRIC DRIVE DEVICE

(71) Applicant: HONDA MOTOR CO., LTD., Tokyo (JP)

(72) Inventor: Takeki KISHI, Saitama (JP)

(21) Appl. No.: 18/974,275

(22) Filed: Dec. 9, 2024

(30) Foreign Application Priority Data
Jan. 17, 2024 (JP) 2024-005637

(51) Int. Cl. H02K 11/33; B64D 27/31; B64D 27/359; B64D 31/16; H02K 5/18; H02K 5/22; H02K 21/14

(52) U.S. Cl. CPC H02K 11/33; B64D 27/359; B64D 31/16; H02K 5/18; H02K 5/225; H02K 21/14; B64D 27/31

(57) ABSTRACT

An electric drive device includes one shaft extending in a prescribed axial direction, a first rotary electric machine and a second rotary electric machine each arranged coaxially with the shaft and connected to the shaft, a first controller electrically connected to the first rotary electric machine and configured to control driving of the first rotary electric machine, and a second controller electrically connected to the second rotary electric machine and configured to control driving of the second rotary electric machine. The first rotary electric machine and the second rotary electric machine are spaced apart from each other in the axial direction of the shaft, and the first controller and the second controller are arranged between the first rotary electric machine and the second rotary electric machine.

### TECHNICAL FIELD

The present invention relates to an electric drive device.

### BACKGROUND ART

In recent years, efforts to realize a low-carbon or carbon-free society have been gaining momentum, and research and development of electrification technologies is being conducted for vehicles to reduce CO₂ emissions and improve energy efficiency. While electric vehicles have become increasingly common owing to research of electrification technologies, electric aircrafts have not yet become common. There are very high safety standards for aircrafts to be satisfied for certification. Thus, high reliability is required for electric drive devices used for electric aircrafts and the like.

For example, US 2022/0340292 A1 discloses an electric aircraft including a two-motor propulsion system. An electric aircraft includes an electric vertical take-off and landing (eVTOL) aircraft. The propulsion system includes a flying component configured to generate thrust, a first electric motor, and a second electric motor. Each of these electric motors is mechanically connected to the flying component and configured to provide power to the flying component. More specifically, the first electric motor and the second electric motor are provided coaxially on a single rotor shaft, and are arranged such that the first electric motor is provided above the second electric motor. In this propulsion system, the second electric motor can provide power to the flying component even if the first electric motor is not working.

However, in the propulsion system described in US 2022/0340292 A1, both a first inverter that generates the power supplied to the first electric motor and a second inverter that generates the power supplied to the second electric motor are arranged below these electric motors. Accordingly, the wire that connects the first electric motor on the upper side and the first inverter needs to be arranged to avoid the second electric motor on the lower side. This requires a design that takes into consideration the arrangement of the wire, and also makes the wire longer. As the wire gets longer, the possibility of the wire disconnection increases, which reduces the electric reliability of the propulsion system.

In view of the above background, an object of the present invention is to provide an electric drive device that can shorten a wire connected to a rotary electric machine and improve the electric reliability. Further, an object thereof is to contribute to reducing CO₂ emissions through the widespread use of the electric drive device.

To achieve such an object, one aspect of the present invention provides an electric drive device (16) comprising: one shaft (38) extending in a prescribed axial direction; a first rotary electric machine (31A) and a second rotary electric machine (31B) each arranged coaxially with the shaft and connected to the shaft; a first controller (72A) electrically connected to the first rotary electric machine and configured to control driving of the first rotary electric machine; and a second controller (72B) electrically connected to the second rotary electric machine and configured to control driving of the second rotary electric machine, wherein the first rotary electric machine and the second rotary electric machine are spaced apart from each other in the axial direction of the shaft, and the first controller and the second controller are arranged between the first rotary electric machine and the second rotary electric machine.

According to this aspect, in the electric drive device where the two rotary electric machines arranged coaxially with the shaft are integrated with the controllers thereof, the controllers are arranged in a space between the rotary electric machines, so that each of the controllers can be connected to the corresponding rotary electric machine with the shortest wire within the abovementioned space. Further, there is no need to arrange the wire to bypass the rotary electric machine. Accordingly, the electric reliability of the electric drive device can be improved.

In the above aspect, preferably, the electric drive device further comprises: a casing (71) that defines a controller storage space (73) between the first rotary electric machine and the second rotary electric machine, the controller storage space being a space for accommodating the first controller and the second controller; and two electric connectors (76) provided on an outer circumferential surface of the casing and connected to the first controller and the second controller.

According to this aspect, the power line connected to an outside power supply or an outside battery can be connected to the electric connectors provided on the outer circumferential surface of the casing. Further, since the electric connectors are provided on the outer circumferential surface of the casing, the length of the power line connecting the electric connectors to the controllers can be shortened.

In the above aspect, preferably, the first controller is arranged in a first space (119) of the controller storage space, the first space having a fan shape centered on the shaft, the second controller is arranged in a second space (120) of the controller storage space, the second space being arranged separately from the first space and having a fan shape centered on the shaft, and a position of the first controller in the axial direction of the shaft and a position of the second controller in the axial direction thereof overlap with each other.

According to this aspect, the two controllers are arranged in the controller storage space between the rotary electric machines such that the two controllers do not overlap in the circumferential direction but overlap in the axial direction of the shaft, so that the dead space can be reduced. Accordingly, the dimension of the controller storage space in the axial direction is reduced, so that the electric drive device can be made compact.

In the above aspect, preferably, the first controller and the second controller are arranged to be rotationally symmetric about a center of the controller storage space.

According to this aspect, it is possible to form the electric drive device by preparing two combinations of the rotary electric machine and the controller with the same arrangement and assembling them in a rotationally symmetric arrangement. Accordingly, the components of the two combinations can be made common, so that the cost of the electric drive device can be reduced.

In the above aspect, preferably, the casing includes a cylindrical casing body (93), and a first wall (94) and a second wall (95) provided on both end surfaces of the casing body in the axial direction, and the first wall has a first opening (116) at a position corresponding to the first controller, and the second wall has a second opening (117) at a position corresponding to the second controller.

According to this aspect, the first controller can be arranged in the first space using the first opening, and the second controller can be arranged in the second space using the second opening. Further, the first controller and the first rotary electric machine can be electrically connected via the first opening, and the second controller and the second rotary electric machine can be electrically connected via the second opening.

In the above aspect, preferably, the first controller and the second controller each include: a power module (77) including a switching element (128); and a smoothing capacitor (79) configured to smooth electric power supplied from a power supply (125) to the power module, and the power module is attached to the casing body, and a cooling fin (96) is provided at least on an outer surface of a portion of the casing body corresponding to the power module.

According to this aspect, the heat from the power module that is likely to become hot is radiated to the outside from the cooling fin via the casing body, so that the power module can be prevented from overheating.

In the above aspect, preferably, the smoothing capacitor is attached to the first wall or the second wall arranged on a side opposite to the corresponding first rotary electric machine or the corresponding second rotary electric machine.

According to this aspect, it is possible to attach the smoothing capacitor to the first wall by accessing the second opening of the second wall, or to attach the smoothing capacitor to the second wall by accessing the first opening of the first wall, so that the attachment of the smoothing capacitor can be facilitated.

In the above aspect, preferably, the smoothing capacitor is arranged on the side opposite to the corresponding first rotary electric machine or the corresponding second rotary electric machine with the corresponding power module interposed therebetween.

According to this aspect, each rotary electric machine and the corresponding power module are arranged close to each other, so that the space between the rotary electric machine different from the corresponding rotary electric machine and the power module can be effectively utilized as the arrangement space for each smoothing capacitor.

In the above aspect, preferably, the smoothing capacitor is arranged on an inside of the corresponding power module in a radial direction of the casing body.

According to this aspect, it is not necessary to extend the controller storage space in the axial direction to secure the arrangement space for each smoothing capacitor. Accordingly, each rotary electric machine and the corresponding power module are arranged close to each other, so that the dimension of the casing in the axial direction can be reduced and the electric drive device can be made compact.

Thus, according to the above aspects, it is possible to provide e an electric drive device that can shorten a wire connected to a rotary electric machine and improve the electric reliability.

### BRIEF DESCRIPTION OF THE DRAWING(S)

FIG. 1 is a perspective view of an aircraft according to an embodiment;

FIG. 2 is a partial cross-sectional view showing a propulsion unit according to the embodiment;

FIG. 3 is a perspective view showing a propulsion drive device according to the embodiment;

FIG. 4 is a cross-sectional view showing the propulsion drive device according to the embodiment;

FIG. 5 is a circuit diagram showing a DC power supply and the propulsion drive device according to the embodiment;

FIG. 6A is a front end surface view of a control unit according to the embodiment;

FIG. 6B is a rear end surface view of the control unit according to the embodiment;

FIG. 7 is a schematic cross-sectional view showing an upper half of the propulsion drive device according to the embodiment; and

FIG. 8 is a schematic cross-sectional view showing an upper half of a propulsion drive device according to a modified embodiment.

### DETAILED DESCRIPTION OF THE INVENTION

### <The Aircraft 1>

In the following, an aircraft 1 (an example of a mobile body) according to an embodiment of the present invention will be described with reference to the drawings.

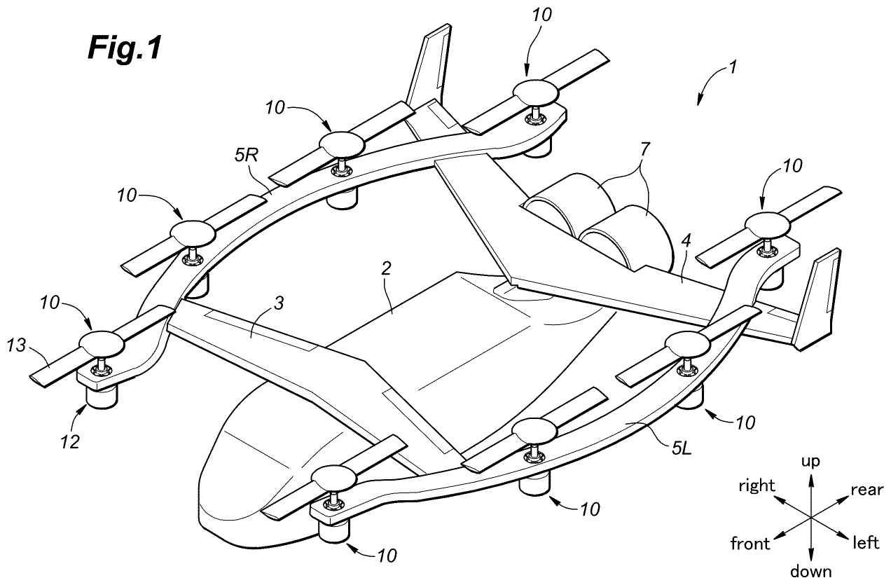

With reference to FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4.

A cabin (not shown) for an occupant to board is provided in the front portion of the body 2. Left and right propulsion units 7 (which will be described later) for applying the forward propulsion force to the aircraft 1 are provided at the rear end of the body 2. The propulsion units 7 may also be called “cruise units”.

The left arm 5L and the right arm 5R are each provided with a plurality of (for example, four) lift units 10 for applying the ascending and descending forces to the aircraft 1. The plurality of lift units 10 is arranged at intervals in the front-and-rear direction. The lift units 10 may also be called “vertical take-off and landing (VTOL) units”. Each lift unit 10 includes a lift drive device 12 and a lift rotor 13 attached to the lift drive device 12. The lift drive device 12 includes an electric motor (not shown), and is configured to rotate the lift rotor 13 by the driving force of the electric motor.

### <The Propulsion Unit 7>

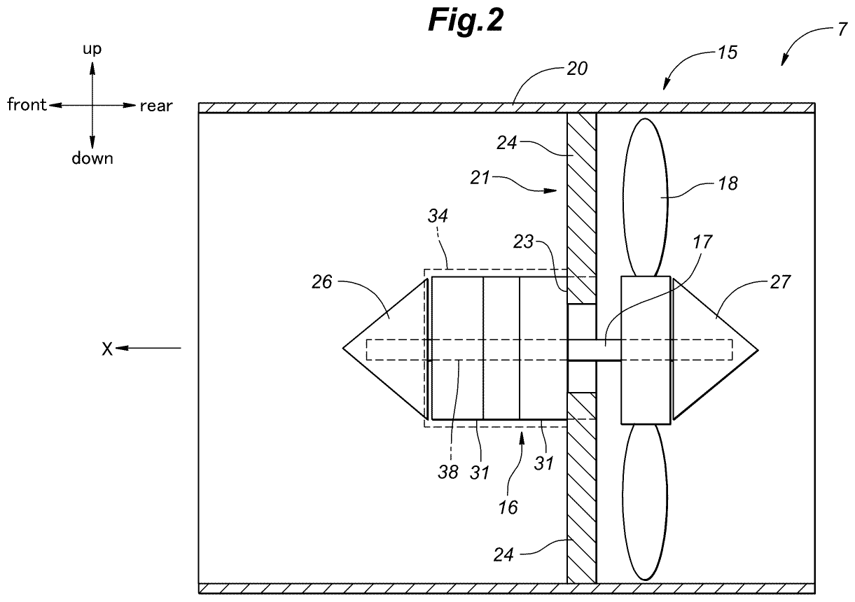

With reference to FIG. 2, each propulsion unit 7 includes a support body 15, a propulsion drive device 16 (an example of an electric drive device) supported by the support body 15, a rotation shaft 17 extending in the front-and-rear direction and rotatably supported by the propulsion drive device 16, and a propulsion rotor 18 fixed to the rear portion of the rotation shaft 17.

The support body 15 is fixed to the rear end of the body 2 (see FIG. 1). The support body 15 includes a cylindrical nacelle 20 extending in the front-and-rear direction, and a mount frame 21 fixed to the inner circumferential surface of the nacelle 20. The mount frame 21 includes an annular hub 23 that is concentric with the nacelle 20, and a plurality of spokes 24 extending radially from the outer circumferential surface of the hub 23 and connected to the inner circumferential surface of the nacelle 20.

The propulsion drive device 16 is accommodated in the nacelle 20. The propulsion drive device 16 is fixed to the front surface of the hub 23 of the mount frame 21. The details of the propulsion drive device 16 will be described later.

The rotation shaft 17 is accommodated in the nacelle 20. The rotation shaft 17 penetrates through the hub 23 of the mount frame 21. A conical front cover 26 the diameter of which increases toward the rear is fixed to the front end of the rotation shaft 17. The front cover 26 is arranged in front of the propulsion drive device 16. A conical rear cover 27 the diameter of which increases toward the front is fixed to the rear end of the rotation shaft 17. The rear cover 27 is arranged behind the central portion of the propulsion rotor 18.

The propulsion rotor 18 is accommodated in the nacelle 20. The propulsion rotor 18 is configured to rotate integrally with the rotation shaft 17 according to the rotation of the rotation shaft 17, thereby applying the forward propulsion force to the aircraft 1.

### <The Propulsion Drive Device 16>

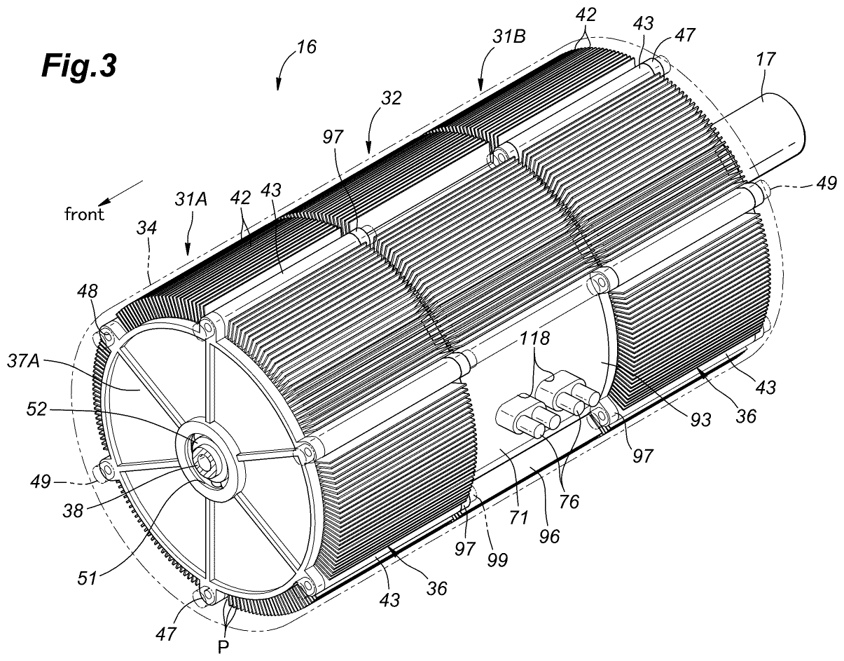

With reference to FIGS. 2 and 3, the propulsion drive device 16 includes a front electric motor 31A (an example of a first rotary electric machine) and a rear electric motor 31B (an example of a second rotary electric machine) spaced apart from each other in the front-and-rear direction, and a control unit 32 arranged between the front electric motor 31A and the rear electric motor 31B. Hereinafter, in a case where the front electric motor 31A and the rear electric motor 31B are not distinguished, the front electric motor 31A or the rear electric motor 31B will be simply referred to as “electric motor 31”. Further, both the front electric motor 31A and the rear electric motor 31B will be referred to as “both electric motors 31”. The propulsion drive device 16 further includes a duct cover 34 that covers the outer circumference of both electric motors 31 and the control unit 32.

### <The Electric Motor 31>

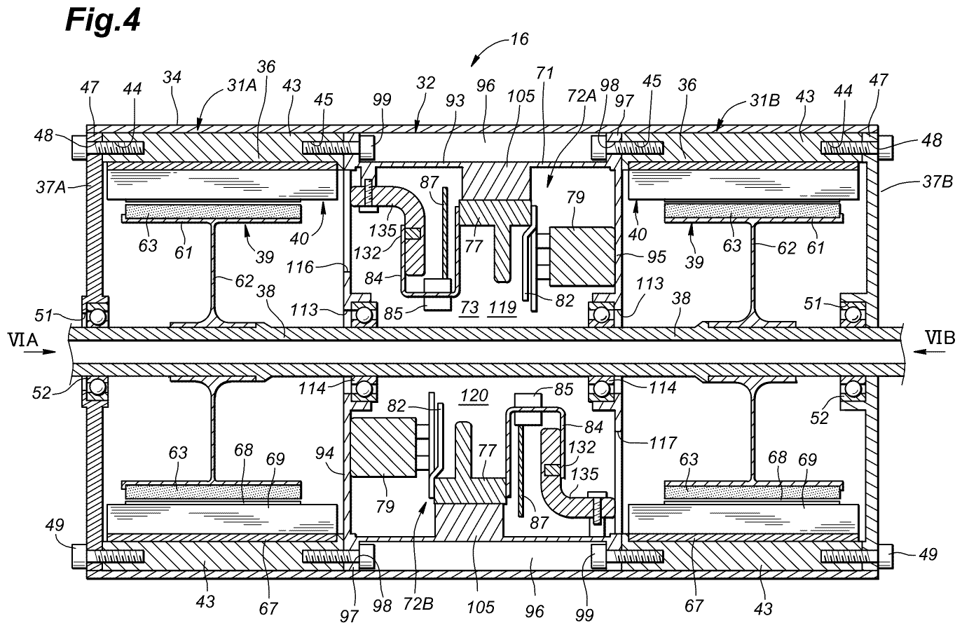

The electric motor 31 is, for example, a three-phase AC motor of an inner rotor type. With reference to FIGS. 3 and 4, the electric motor 31 includes a housing 36, a lid 37 (a front lid 37A or a rear lid 37B), a shaft 38, a rotor 39, and a stator 40. The configurations of both electric motors 31 are different in the lid 37, but substantially the same in other components. Hereinafter, unless otherwise specified, the description of the electric motor 31 will be applied to both electric motors 31.

The housing 36 is cylindrical and extends in the front-and-rear direction on the outer circumference of the shaft 38. The housing 36 is arranged on the outer circumference of the rotor 39 and the stator 40 and accommodates the rotor 39 and the stator 40 (an example of structural components of the electric motor 31).

The front lid 37A of the front electric motor 31A is attached to the front end of the housing 36 so as to cover the front opening of the housing 36. The rear lid 37B of the rear electric motor 31B is attached to the rear end of the housing 36 so as to close the rear opening of the housing 36. In a case where the front lid 37A and the rear lid 37B are not distinguished, the front lid 37A or the rear lid 37B will be simply referred to as “lid 37”.

A plurality of first cooling fins 42 protrudes from the outer circumferential surface of the housing 36 at intervals in the circumferential direction of the housing 36. The plurality of first cooling fins 42 is formed integrally with the housing 36. Each first cooling fin 42 has a flat plate shape and extends along the front-and-rear direction. Each first cooling fin 42 extends continuously from the front end (one end in the front-and-rear direction) of the housing 36 to the rear end (the other end in the front-and-rear direction) thereof.

A plurality of fastening protrusions 43 protrudes from the outer circumferential surface of the housing 36 at intervals in the circumferential direction of the housing 36. The plurality of fastening protrusions 43 is provided between adjacent first cooling fins 42. Passages P of the cooling air that extend continuously from the front end of the housing 36 to the rear end thereof are formed between the adjacent first cooling fins 42 and between the adjacent first cooling fins 42 and each fastening protrusion 43. The plurality of fastening protrusions 43 is formed integrally with the housing 36.

Each fastening protrusion 43 is a rod-shaped portion with a substantially rectangular cross-section having a semicircular top, and extends along the front-and-rear direction. That is, each fastening protrusion 43 extends parallel to each first cooling fin 42. Each fastening protrusion 43 extends continuously from the front end (one end in the front-and-rear direction) of the housing 36 to the rear end (the other end in the front-and-rear direction) thereof. Each fastening protrusion 43 is integrally formed of the same material from the front end (one end in the front-and-rear direction) of each fastening protrusion 43 to the rear end (the other end in the front-and-rear direction) thereof.

The front end of each fastening protrusion 43 of the front electric motor 31A is provided with a first bolt hole 44 for fastening the front lid 37A to the housing 36. The rear end of each fastening protrusion 43 is provided with a second bolt hole 45 for fastening a casing 71 of the control unit 32 (which will be described later) to the housing 36. The first bolt hole 44 and the second bolt hole 45 extend along the front-and-rear direction.

The rear end of each fastening protrusion 43 of the rear electric motor 31B is provided with a first bolt hole 44 for fastening the rear lid 37B to the housing 36. The front end of each fastening protrusion 43 is provided with a second bolt hole 45 for fastening the casing 71 of the control unit 32 (which will be described later) to the housing 36. The first bolt hole 44 and the second bolt hole 45 extend along the front-and-rear direction.

The front lid 37A is adjacent to the front housing 36 (the housing 36 of the front electric motor 31A), and closes the opening on the front side (the side opposite to the control unit 32) of the front housing 36. The front lid 37A is a disk-shaped member, and extends along a plane perpendicular to the front-and-rear direction. The front lid 37A is formed separately from the front housing 36. In another embodiment, the front lid 37A may be formed integrally with the front housing 36.

The rear lid 37B is adjacent to the rear housing 36 (the housing 36 of the rear electric motor 31B), and closes the opening on the rear side (the side opposite to the control unit 32) of the rear housing 36. The rear lid 37B is a disk-shaped member (or a conical member), and extends along a plane perpendicular to the front-and-rear direction. The rear lid 37B is formed separately from the rear housing 36. In another embodiment, the rear lid 37B may be formed integrally with the rear housing 36.

A plurality of first fastening pieces 47 protrudes from the outer circumferential portion of the lid 37 at intervals in the circumferential direction of the lid 37. Each first fastening piece 47 is provided with a first fastening hole 48 formed in the front-and-rear direction. The lid 37 is fastened to the housing 36 as a first fastening bolt 49 penetrating through the first fastening hole 48 engages with the first bolt hole 44 of each fastening protrusion 43 of the housing 36. A circular first through hole 51 is provided in the front-and-rear direction in the central portion of the lid 37. A first bearing 52 is attached to the first through hole 51.

With reference to FIG. 2, the shaft 38 extends in the front-and-rear direction (an example of the prescribed axial direction). The shaft 38 constitutes a portion of the rotation shaft 17 of the propulsion unit 7. Accordingly, as the shaft 38 rotates, the entire rotation shaft 17 rotates, and the propulsion rotor 18 rotates integrally with the rotation shaft 17. This applies the forward propulsion force to the aircraft 1, thereby propelling the aircraft 1 forward. The shaft 38 extends along the propulsion direction of the aircraft 1 (see an arrow X in FIG. 2).

In the present embodiment, the shaft 38 is composed of a single shaft member that is common to the front and rear electric motors 31A, 31B. In another embodiment, the front and rear electric motors 31A, 31B may each have a shaft member, and the shaft members of the front and rear electric motors 31A, 31B may be coaxially arranged and connected to each other to form one shaft 38.

With reference to FIG. 4, the shaft 38 is hollow. The shaft 38 penetrates through the inside of the control unit 32 in the front-and-rear direction, and also penetrates through the front and rear housings 36. The shaft 38 penetrates through the first through hole 51 of the front lid 37A and extends forward. The front end of the shaft 38 supports the front cover 26 (see FIG. 2). The shaft 38 is rotatably supported by the front lid 37A via the first bearing 52. The rear end of the shaft 38 is arranged in the first through hole 51 of the rear lid 37B and connected to the front end of the rotation shaft 17 (see FIG. 2). The shaft 38 is rotatably supported by the rear lid 37B via the first bearing 52.

The rotor 39 is hollow. The rotor 39 is arranged on the outer circumference of the shaft 38. The rotor 39 includes a cylindrical rotor core 61 extending in the front-and-rear direction, a rotor plate 62 extending in the radial direction and connecting the shaft 38 and the rotor core 61, and a plurality of permanent magnets 63 fixed to the outer circumferential surface of the rotor core 61. The rotor core 61 and the rotor plate 62 are formed integrally with the shaft 38. The rotor plate 62 is provided with a plurality of communication holes (not shown) penetrating therethrough in the front-and-rear direction.

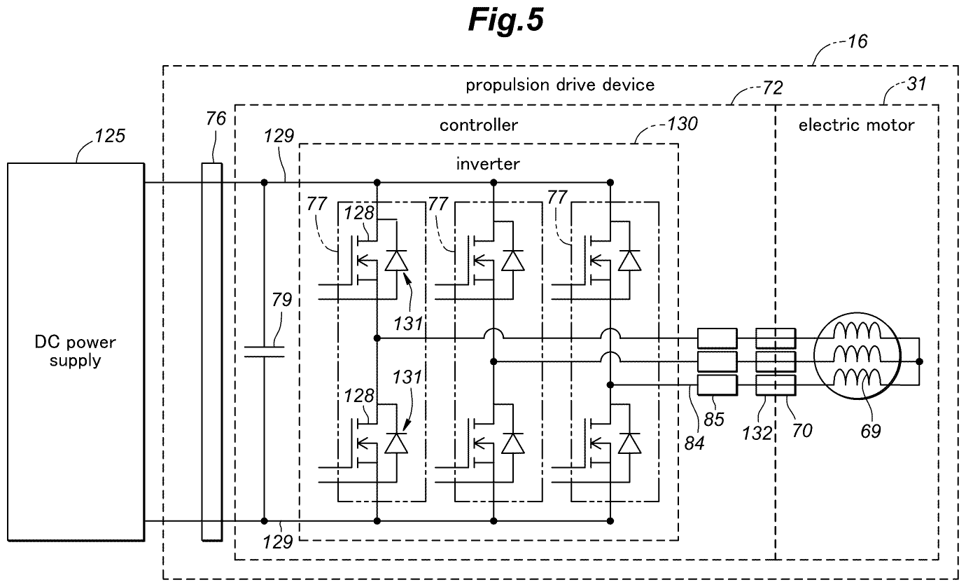

The stator 40 is arranged on the outer circumference of the rotor 39 and faces the rotor 39 at a distance. The stator 40 includes a cylindrical stator core 67 extending in the front-and-rear direction, a plurality of teeth 68 protruding from the inner circumferential surface of the stator core 67, a plurality of coils 69 wound around the plurality of teeth 68, and three motor terminals 70 (see FIG. 5: an example of terminals of the rotary electric machine) connected to the plurality of coils 69. The stator core 67 is fixed to the inner circumferential surface of the housing 36. Among the components of the electric motor 31 and the control unit 32, the plurality of coils 69 has the greatest heat generation. Accordingly, the heat generation of the electric motor 31 is greater than the heat generation of the control unit 32. The three motor terminals 70 correspond to the U-phase, V-phase, and W-phase of the three-phase AC, respectively.

### <The Control Unit 32>

With reference to FIG. 3, the control unit 32 is integrated with the front and rear electric motors 31A, 31B and controls driving of the front and rear electric motors 31A, 31B. In other words, the propulsion drive device 16 according to the present embodiment is a drive device that integrates a mechanical component with an electrical component.

With reference to FIG. 4, the control unit 32 includes a casing 71 and two controllers 72 (an upper controller 72A and a lower controller 72B) arranged in the upper and lower portions of the casing 71. The upper controller 72A (an example of a first controller) is configured to control driving of the front electric motor 31A, and the lower controller 72B (an example of a second controller) is configured to control driving of the rear electric motor 31B. Hereinafter, in a case where the upper controller 72A and the lower controller 72B are not distinguished, the upper controller 72A or the lower controller 72B will be simply referred to as “controller 72 (or each controller 72)”. Further, both the upper controller 72A and the lower controller 72B will be referred to as “both controllers 72”.

The casing 71 of the control unit 32 is arranged between the housings 36 of the front and rear electric motors 31A, 31B. The casing 71 is made of metal. The casing 71 defines therein a controller storage space 73 between the front and rear electric motors 31A, 31B. The controller storage space 73 is a space for accommodating both controllers 72.

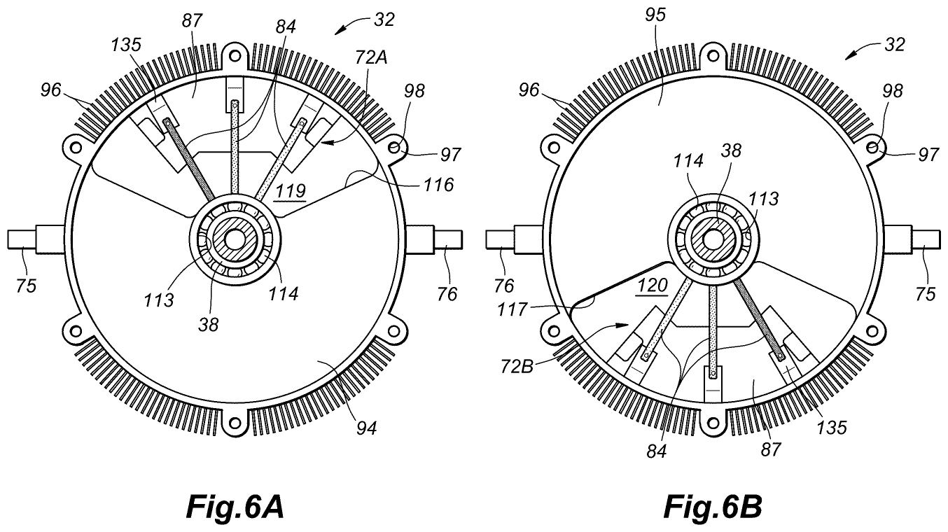

Each controller 72 is connected to communication connectors 75 (see FIG. 6) and DC input connectors 76 (see FIGS. 3 and 6, an example of electric connectors). Each controller 72 includes three power modules 77 fixed by fixing members (not shown), a smoothing capacitor 79, two DC bus bars 82, three AC bus bars 84, three electric current sensors 85, and a board 87.

The casing 71 includes a cylindrical circumferential wall 93 (an example of a casing body) that extends in the front-and-rear direction on the outer circumference of the shaft 38. The circumferential wall 93 forms the casing body of the casing 71 that defines the controller storage space 73. The casing 71 also includes a front wall 94 (an example of a first wall) that closes the front opening of the circumferential wall 93 facing the front electric motor 31A, and a rear wall 95 (an example of a second wall) that closes the rear opening of the circumferential wall 93 facing the rear electric motor 31B.

Hereinafter, the term “circumferential direction” used in the description of the components of the control unit 32 will refer to the circumferential direction of the circumferential wall 93 of the casing 71 (in other words, the circumferential direction centered on the shaft 38). Further, the term “axial direction” used in the description of the components of the control unit 32 will refer to the axial direction of the circumferential wall 93 of the casing 71 (in other words, the axial direction of the shaft 38). Further, the term “radial direction” used in the description of the components of the control unit 32 will refer to the radial direction of the circumferential wall 93 of the casing 71 (in other words, the radial direction of the shaft 38).

With reference to FIGS. 3 and 4, a plurality of second cooling fins 96 protrudes from the outer circumferential surface of the circumferential wall 93 of the casing 71 at intervals in the circumferential direction. The plurality of second cooling fins 96 is formed integrally with the circumferential wall 93. Each second cooling fin 96 has a flat plate shape and extends along the front-and-rear direction. Each second cooling fin 96 extends continuously from the front end (one end in the front-and-rear direction) of the circumferential wall 93 to the rear end (the other end in the front-and-rear direction) thereof.

The left portion of the outer circumferential surface of the circumferential wall 93 does not include the second cooling fins 96, but includes two DC input connectors 76 instead. One DC input connector 76 is a connector for supplying DC power to the upper controller 72A. The other DC input connector 76 is a connector for supplying DC power to the lower controller 72B.

A plurality of second fastening pieces 97 protrudes from each of the front and rear ends of the outer circumferential surface of the casing 71 at intervals in the circumferential direction. Each second fastening piece 97 is provided with a second fastening hole 98 formed in the front-and-rear direction. A second fastening bolt 99 that penetrates through the second fastening hole 98 engages with the second bolt hole 45 of each fastening protrusion 43 of the front and rear housings 36. Accordingly, the casing 71 is fastened to the front and rear housings 36.

With reference to FIG. 4, a total of six pedestals 105 (three pedestals 105 on the upper side and three pedestals 105 on the lower side) protrude from the inner circumferential surface of the circumferential wall 93 of the casing 71 at intervals in the circumferential direction. The three power modules 77 of the upper controller 72A contact with the inner surfaces of three pedestals 105 arranged on the upper portion of the circumferential wall 93 of the casing 71. The three power modules 77 of the lower controller 72B contact with the inner surfaces of three pedestals 105 arranged on the lower portion of the circumferential wall 93 of the casing 71.

The position of each power module 77 in the circumferential direction does not overlap with the positions of the plurality of second fastening pieces 97 (i.e., the fastening points between the casing 71 and the housings 36) in the circumferential direction, but overlaps with the positions of the plurality of second cooling fins 96 in the circumferential direction.

The front wall 94 and the rear wall 95 of the casing 71 are disk-shaped members, and extend along a plane perpendicular to the front-and-rear direction. The front wall 94 and the rear wall 95 are formed separately from the circumferential wall 93 and are fixed to the circumferential wall 93 by appropriate means. In another embodiment, the front wall 94 may be formed integrally with the circumferential wall 93.

A circular second through hole 113 is provided in the front-and-rear direction in the central portion of each of the front wall 94 and the rear wall 95 of the casing 71. A third bearing 114 is attached to each second through hole 113. The shaft 38 passes through the second through hole 113. The shaft 38 is rotatably supported by the front wall 94 and the rear wall 95 of the casing 71 via the third bearing 114.

A first opening 116 having a fan shape centered on the shaft 38 is formed in the upper portion of the front wall 94. A second opening 117 having a fan shape centered on the shaft 38 is formed in the lower portion of the rear wall 95. Three AC lines (not shown) extending from the coils 69 of the front electric motor 31A to the three motor terminals 70 (FIG. 5) thereof are arranged to pass through the first opening 116. Three AC lines (not shown) extending from the coils 69 of the rear electric motor 31B to the three motor terminals 70 (FIG. 5) thereof are arranged to pass through the second opening 117.

A resolver (not shown) is provided on the front wall 94 and the rear wall 95 of the casing 71 on the side opposite to the side on which the third bearing 114 is provided. The resolver includes a plurality of detection portions arranged at intervals in the circumferential direction, and detects the rotation of the shaft 38.

With reference to FIG. 5, the DC input connectors 76 are connected to a DC power supply 125 provided outside the propulsion drive device 16. For example, the DC power supply 125 may be composed of a battery or a generator.

Although the propulsion drive device 16 includes two controllers 72 and two electric motors 31, only one of the controllers 72 and one of the electric motors 31 are shown in FIG. 5.

With reference to FIG. 3, the DC input connectors 76 fit into first fitting holes 118 of the circumferential wall 93 of the casing 71 and penetrate through the circumferential wall 93 of the casing 71. A pair of DC input terminals to which the two DC bus bars 82 (FIG. 4) are connected are provided on the inner surface (the surface on the side of the electric motor 31) of the DC input connectors 76.

With reference to FIG. 5, the three power modules 77 each include two switching elements 128. That is, the controller 72 includes a total of six switching elements 128. The six switching elements 128 are components of an inverter 130 (an example of a power conversion circuit) that converts DC power (direct current) input from the DC power supply 125 via a pair of DC lines 129 into AC power (alternating current). Each switching element 128 is composed of a semiconductor element such as an IGBT or a MOSFET. Each switching element 128 is arranged in parallel with a freewheel diode 131.

The smoothing capacitor 79 is connected to the DC power supply 125 in parallel with the inverter 130. The smoothing capacitor 79 smooths the direct current input to the inverter 130 from the DC power supply 125. More specifically, the smoothing capacitor 79 protects the three power modules 77 by smoothing a pulse electric current (a pulse-shaped electric current caused by a surge voltage) generated in the direct current input from the DC power supply 125 to the three power modules 77.

With reference to FIG. 4, the smoothing capacitor 79 of the upper controller 72A is attached to the rear wall 95 of the casing 71. The smoothing capacitor 79 of the lower controller 72B is attached to the front wall 94 of the casing 71. Each smoothing capacitor 79 is arranged at an interval from the inner circumferential surface of the circumferential wall 93 of the casing 71. Each smoothing capacitor 79 is arranged on the upper side or the lower side of the casing 71 together with the corresponding three power modules 77.

More specifically, the upper controller 72A is arranged in an upper space 119 (an example of a first space) of the controller storage space 73. The lower controller 72B is arranged in a lower space 120 (an example of a second space) of the controller storage space 73. Each controller 72 includes the AC bus bars 84 and electronic components such as the three power modules 77, the smoothing capacitor 79, the three electric current sensors 85, and the board 87, but does not include the DC input connectors 76. The upper space 119 is a space having a fan shape centered on the shaft 38, and the angle of the fan shape thereof is less than 180°. The lower space 120 is a space arranged separately from the upper space 119 in the circumferential direction (in other words, arranged not to overlap with the upper space 119 in the circumferential direction) and having a fan shape centered on the shaft 38, and the angle of the fan shape thereof is less than 180°.

The upper controller 72A is arranged in the whole of the upper space 119 in the axial direction. The lower controller 72B is arranged in the whole of the lower space 120 in the axial direction. In other words, the upper controller 72A and the lower controller 72B are arranged in the controller storage space 73 at positions that do not overlap with each other in the circumferential direction but overlap with each other in the axial direction.

With reference to FIG. 5, the alternating current output from the inverter 130 (three power modules 77) is output to each coil 69 of the electric motor 31 via each AC output terminal 132 and each motor terminal 70.

With reference to FIGS. 4 and 5, the three electric current sensors 85 are respectively arranged on the three AC bus bars 84 (three-phase lines) that extend from the inverter 130 (three power modules 77) to each coil 69 of the electric motor 31. The electric current sensors 85 detect the values of the electric current output from the three power modules 77. The three AC bus bars 84 are supported by three bus bar fastening stays 135 attached to the inner circumferential surface of the circumferential wall 93 of the casing 71.

The board 87 is an ECU board that controls driving of the inverter 130 (three power modules 77). The board 87 is arranged between the power modules 77 and the bus bar fastening stays 135 and may be attached to the circumferential wall 93 of the casing 71 via, for example, a member that presses the power modules 77 against the pedestals 105.

### <The Duct Cover 34>

With reference to FIGS. 3 and 4, the duct cover 34 has a cylindrical shape extending in the front-and-rear direction. A cooling air passage P is formed between the duct cover 34 and both the housing 36 of the electric motor 31 and the circumferential wall 93 of the casing 71 of the control unit 32. That is, the cooling air passage P is formed on the outer circumference of the housing 36 of the electric motor 31 and the casing 71 of the control unit 32. The cooling air passage P has a cylindrical shape and extends in the front-and-rear direction.

### <Cooling of the Electric Motor 31 and the Control Unit 32>

With reference to FIGS. 2 to 4, when the electric motor 31 is driven and the shaft 38 rotates, the propulsion rotor 18 fixed to the rotation shaft 17 rotates integrally with the shaft 38. Accordingly, a portion of the air, which is generated by the propulsion rotor 18 and flowing rearward within the nacelle 20, flows as cooling air between the duct cover 34 and both the outer circumferential surface of the housing 36 and the outer circumferential surface of the circumferential wall 93 of the casing 71. That is, the cooling air is introduced into the cooling air passage P by the propulsion rotor 18.

The cooling air introduced into the cooling air passage P flows from the front side to the rear side on the outer circumference of the housing 36 of the front electric motor 31A and between the first cooling fins 42. Accordingly, the front electric motor 31A is cooled by the cooling air. Next, the cooling air flows from the front side to the rear side on the outer circumference of the circumferential wall 93 of the casing 71 of the control unit 32 and between the plurality of second cooling fins 96. Accordingly, the casing 71 of the control unit 32 is cooled by the cooling air. Next, the cooling air flows from the front side to the rear side on the outer circumference of the housing 36 of the rear electric motor 31B and between the first cooling fins 42. Accordingly, the rear electric motor 31B is cooled by the cooling air. The cooling air that has passed through the outer circumference of the rear electric motor 31B is discharged from the rear end of the cooling air passage P to the rear space thereof.

FIG. 6A is a front end surface view of the control unit 32, and FIG. 6B is a rear end surface view of the control unit 32. FIG. 6A shows the control unit 32 viewed along an arrow VIA in FIG. 4, and FIG. 6B shows the control unit 32 viewed along an arrow VIB in FIG. 4. With reference to FIGS. 6A and 6B, the first opening 116 of the front wall 94 is formed into a fan shape at a position corresponding to the upper space 119 of the controller storage space 73. The second opening 117 of the rear wall 95 is formed into a fan shape at a position corresponding to the lower space 120 of the controller storage space 73. The front wall 94 and the rear wall 95 have shapes rotationally symmetric with each other by 180° in a front view. The upper controller 72A and the lower controller 72B are arranged to be rotationally symmetric with each other by 180°.

### <Effects>

The aircraft 1 and the propulsion drive device 16 according to the embodiment are configured as described above. In the following, the effects of the propulsion drive device 16 having such a configuration will be described.

With reference to FIG. 2, the propulsion drive device 16 integrally includes one shaft 38, the front electric motor 31A and the rear electric motor 31B each arranged coaxially with the shaft 38, the upper controller 72A, and the lower controller 72B. In other words, the propulsion drive device 16 is configured such that the two electric motors 31 arranged coaxially with the shaft 38 are integrated with the controllers 72 of the respective electric motors 31. With reference to FIG. 4, both electric motors 31 are spaced apart from each other in the axial direction of the shaft 38, and both controllers 72 are arranged between both electric motors 31. The controllers 72 of the respective electric motors 31 are arranged in a space between both electric motors 31 in this manner, so that each controller 72 can be connected to the corresponding electric motor 31 with the shortest wire within the abovementioned space. Further, there is no need to arrange the wire to bypass the electric motor 31. Accordingly, the electric reliability of the propulsion drive device 16 can be improved.

The propulsion drive device 16 further includes the casing 71 that defines the controller storage space 73 for accommodating both controllers 72 between both electric motors 31, and the two DC input connectors 76 (see FIG. 3) provided on the outer circumferential surface of the casing 71 and connected to both controllers 72. Accordingly, the power line connected to the outside DC power supply 125 (FIG. 5) can be connected to the DC input connectors 76 provided on the outer circumferential surface of the casing 71. Further, since the DC input connectors 76 are provided on the outer circumferential surface of the casing 71, the length of the power line connecting the DC input connectors 76 to each controller 72 can be shortened.

The upper controller 72A is arranged in the upper space 119 of the controller storage space 73, the lower controller 72B is arranged in the lower space 120 of the controller storage space 73, and the positions of both controllers 72 in the axial direction of the shaft 38 overlap with each other. Accordingly, the two controllers 72 are arranged in the controller storage space 73 between both electric motors 31 such that the two controllers 72 do not overlap with each other in the circumferential direction but overlap with each other in the axial direction of the shaft 38, so that the dead space can be reduced. Accordingly, the dimension of the controller storage space 73 in the axial direction is reduced, so that the propulsion drive device 16 can be made compact.

With reference to FIGS. 4 and 6, both controllers 72 are arranged to be rotationally symmetric about the center of the controller storage space 73. Accordingly, it is possible to form the propulsion drive device 16 by preparing two combinations of the electric motor 31 and the controller 72 with the same arrangement and assembling them in a rotationally symmetric arrangement. Accordingly, the components of the two combinations can be made common, so that the cost of the propulsion drive device 16 can be reduced.

The casing 71 includes the front wall 94 and the rear wall 95 provided on both end surfaces of the cylindrical circumferential wall 93 in the axial direction, the front wall 94 has the first opening 116 at a position corresponding to the upper controller 72A, and the rear wall 95 has the second opening 117 at a position corresponding to the lower controller 72B. Accordingly, the upper controller 72A can be arranged in the upper space 119 using the first opening 116, and the lower controller 72B can be arranged in the lower space 120 using the second opening 117. Further, it is possible to electrically connect the upper controller 72A and the front electric motor 31A by causing an AC wire of the front electric motor 31A to pass through the first opening 116, and to electrically connect the lower controller 72B and the rear electric motor 31B by causing an AC wire of the rear electric motor 31B to pass through the second opening 117.

Each controller 72 includes the power modules 77, and the smoothing capacitor 79 configured to smooth the electric power supplied from the DC power supply 125 to the power modules 77. The power modules 77 are attached to the circumferential wall 93, and the second cooling fins 96 are provided at least on the outer surface of a portion of the circumferential wall 93 corresponding to the power modules 77. Accordingly, the heat from the power modules 77 that are likely to become hot is radiated to the outside from the second cooling fins 96 via the circumferential wall 93, so that the power modules 77 can be prevented from overheating.

The smoothing capacitor 79 is attached to the front wall 94 or the rear wall 95 arranged on the side opposite to the corresponding electric motor 31. Accordingly, it is possible to attach the smoothing capacitor 79 to the front wall 94 by accessing the second opening 117 of the rear wall 95 or to attach the smoothing capacitor 79 to the rear wall 95 by accessing the first opening 116 of the front wall 94, so that the attachment of the smoothing capacitor 79 can be facilitated.

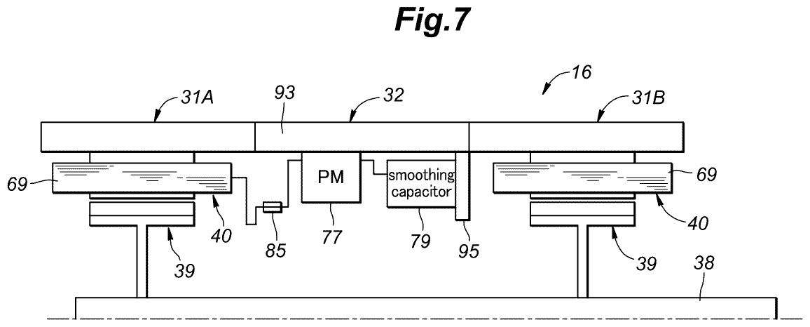

With reference to FIGS. 4 and 7, the smoothing capacitor 79 is arranged on the side opposite to the corresponding electric motor 31 with the corresponding power modules 77 interposed therebetween. Accordingly, each electric motor 31 and the corresponding power modules 77 are arranged close to each other, so that the space between the electric motor 31 different from the corresponding electric motor 31 and the power modules 77 can be effectively utilized as the arrangement space for each smoothing capacitor 79.

### <The Modified Embodiment>

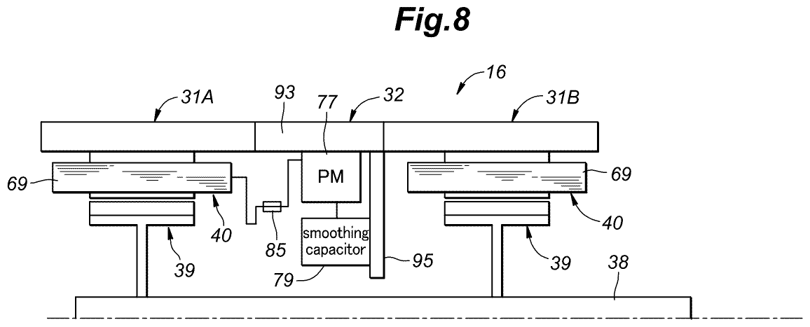

Next, the propulsion drive device 16 according to the modified embodiment will be described. FIG. 8 is a schematic cross-sectional view corresponding to FIG. 7 and showing the upper half of the propulsion drive device 16 according to the modified embodiment. As shown in FIG. 8, in this modified embodiment, the arrangement of the power modules 77 and the smoothing capacitor 79 is different from that of the above embodiment (FIG. 7). In the embodiment shown in FIGS. 4 and 7, the smoothing capacitor 79 is arranged on the side opposite to the corresponding electric motor 31 with the power modules 77 interposed therebetween.

In contrast, in the modified embodiment, the smoothing capacitor 79 is arranged on an inside of the corresponding power modules 77 in the radial direction of the casing 71. Accordingly, it is not necessary to extend the controller storage space 73 in the axial direction to secure the arrangement space for each smoothing capacitor 79. Accordingly, each electric motor 31 and the corresponding power modules 77 are arranged close to each other, so that the dimension of the casing 71 in the axial direction can be reduced and the propulsion drive device 16 can be made compact.

In the above embodiment, the electric motor 31 of an inner rotor type is an example of a rotary electric machine. In another embodiment, an electric motor of an outer rotor type may be an example of the rotary electric machine, or a generator may be an example of the rotary electric machine.

In the above embodiment, the configuration of the present invention is applied to the propulsion drive device 16. In another embodiment, the configuration of the present invention may be applied to the lift drive device 12.

In the above embodiment, the configuration of the present invention is applied to an electric vertical take-off and landing aircraft. In another embodiment, the configuration of the present invention may be applied to an aircraft other than an electric vertical take-off and landing aircraft (i.e., a general aircraft that cannot take off and land vertically), or the configuration of the present invention may be applied to a mobile body other than an aircraft (for example, a vehicle such as an automobile or a motorcycle). Further, in another embodiment, the configuration of the present invention may be applied to a device that is fixedly installed.

This concludes the description of the specific embodiments, but the present invention is not limited to the above embodiments or modifications, and can be widely modified and implemented.

1. An electric drive device, comprising:
one shaft extending in a prescribed axial direction;
a first rotary electric machine and a second rotary electric machine each arranged coaxially with the shaft and connected to the shaft;
a first controller electrically connected to the first rotary electric machine and configured to control driving of the first rotary electric machine; and
a second controller electrically connected to the second rotary electric machine and configured to control driving of the second rotary electric machine,
wherein the first rotary electric machine and the second rotary electric machine are spaced apart from each other in the axial direction of the shaft, and the first controller and the second controller are arranged between the first rotary electric machine and the second rotary electric machine.

2. The electric drive device according to claim 1, further comprising:
a casing that defines a controller storage space between the first rotary electric machine and the second rotary electric machine, the controller storage space being a space for accommodating the first controller and the second controller; and
two electric connectors provided on an outer circumferential surface of the casing and connected to the first controller and the second controller.

3. The electric drive device according to claim 2, wherein the first controller is arranged in a first space of the controller storage space, the first space having a fan shape centered on the shaft,
the second controller is arranged in a second space of the controller storage space, the second space being arranged separately from the first space and having a fan shape centered on the shaft, and
a position of the first controller in the axial direction of the shaft and a position of the second controller in the axial direction thereof overlap with each other.

4. The electric drive device according to claim 2, wherein the first controller and the second controller are arranged to be rotationally symmetric about a center of the controller storage space.

5. The electric drive device according to claim 2, wherein the casing includes a cylindrical casing body, and a first wall and a second wall provided on both end surfaces of the casing body in the axial direction, and
the first wall has a first opening at a position corresponding to the first controller, and the second wall has a second opening at a position corresponding to the second controller.

6. The electric drive device according to claim 5, wherein the first controller and the second controller each include:
a power module including a switching element; and
a smoothing capacitor configured to smooth electric power supplied from a power supply to the power module, and
the power module is attached to the casing body, and a cooling fin is provided at least on an outer surface of a portion of the casing body corresponding to the power module.

7. The electric drive device according to claim 6, wherein the smoothing capacitor is attached to the first wall or the second wall arranged on a side opposite to the corresponding first rotary electric machine or the corresponding second rotary electric machine.

8. The electric drive device according to claim 7, wherein the smoothing capacitor is arranged on the side opposite to the corresponding first rotary electric machine or the corresponding second rotary electric machine with the corresponding power module interposed therebetween.

9. The electric drive device according to claim 7, wherein the smoothing capacitor is arranged on an inside of the corresponding power module in a radial direction of the casing body.
